(19) United States
(12) Patent Application Publication
(10) Pub. No.: US 2013/0283979 A1
(43) Pub. Date: Oct. 31, 2013

(54) CAP WRENCH FOR MILITARY STYLE FUEL CANS

(71) Applicant: Frederic Thomas Nott, Brooksville, FL (US)

(72) Inventor: Frederic Thomas Nott, Brooksville, FL (US)

(73) Assignee: Frederic Thomas Nott, Brooksville, FL (US)

(21) Appl. No.: 13/400,082

(22) Filed: Feb. 19, 2012

(51) Int. Cl. B67B 7/18

(52) U.S. Cl. CPC B67B 7/18
USPC 81/3.4; 53/492

(57) ABSTRACT

A tool for removal of a portable fuel container cap includes a scalloped interior opening in a circular head attached to at least one handle. The application of torque by this tool to the cap of a portable fuel container for easy removal and tightening of said cap from the container.

### BACKGROUND OF THE INVENTION

This application relates to portable fuel containers, particularly to a jerry style can.

It has been found that portable fuel containers, when exposed to temperature fluctuations, left to sit for extended periods, or overtightened can become very difficult or impossible to remove the caps from with a reasonable amount of force. Utilizing a strap wrench for the removal of a tight fitting cap is difficult in itself and can lead to damaged caps which can result in fuel or vapor leaks. It is therefore desirable to provide a suitable tool for safely releasing, removing, and replacing the cap of the portable fuel container.

The present invention accomplishes its desired objective by providing a tool for the easy removal of the cap from a portable fuel container.

No U.S. patents have been found that teach or suggest the particular fuel cap removal tool of this invention.

### SUMMARY

The invention, now referred to as a cap wrench, includes a handle adapted to be manually gripped by the user for turning the fastener element The handle has at least one end having an opening that is the size and shape that are complimentary to the size and shape of the fastener to be turned, and adapted to be readily engageable and disengageable therewith.

In one embodiment of the invention, the cap wrench has a handle and a head connected to one end of the handle. The head is sized appropriately to receive and accept the cap of the portable fuel container and withstand the forces exerted during the opening of the can. When the fuel can cap is inserted into the recess of the head end of the cap wrench, the arcuate recesses engage the protrusions on the cap. When the cap wrench is turned while seated properly on the cap, the arcuate recesses provide even pressure to the protrusions on the cap. The even pressure applied to all of the protrusions simultaneously ensures that the integrity of the cap is not compromised in any way.

### ADVANTAGES

Accordingly, several advantages of one or more aspects are as follows: to provide a tool that can easily remove tight fitting caps from portable fuel containers, that will not damage the cap when used as intended, that is lightweight, and that is durable. Other advantages of one or more aspects will be apparent from a consideration of the drawings and ensuing description.

### DRAWINGS

### Figures

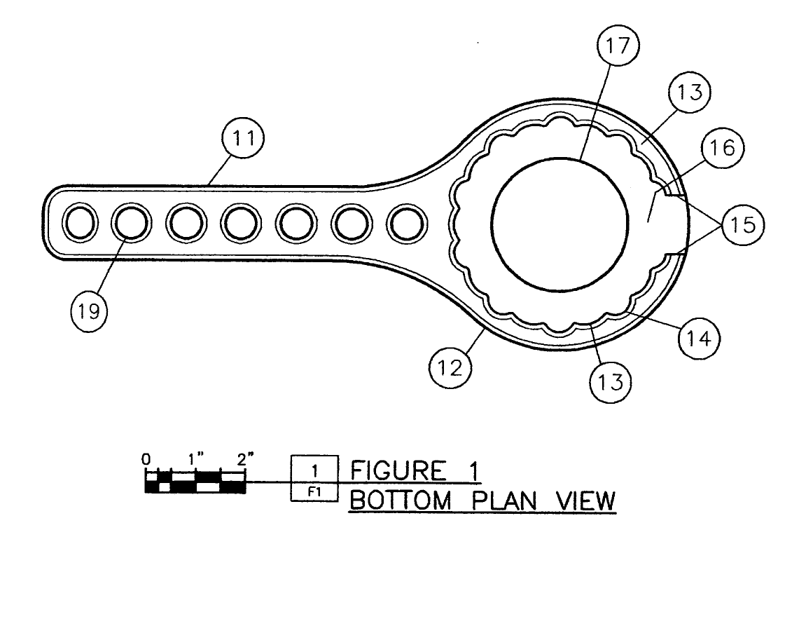

FIG. 1. 1st Embodiment, flat, bottom view

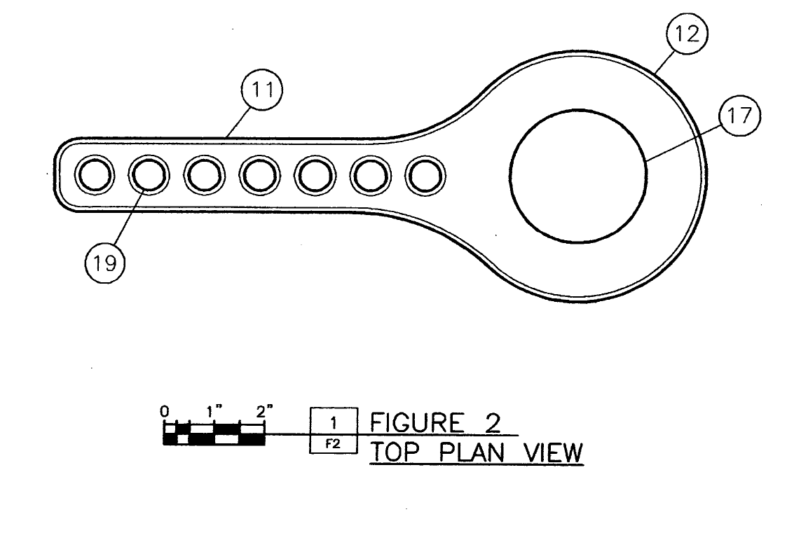

FIG. 2. 1st Embodiment, flat, top view

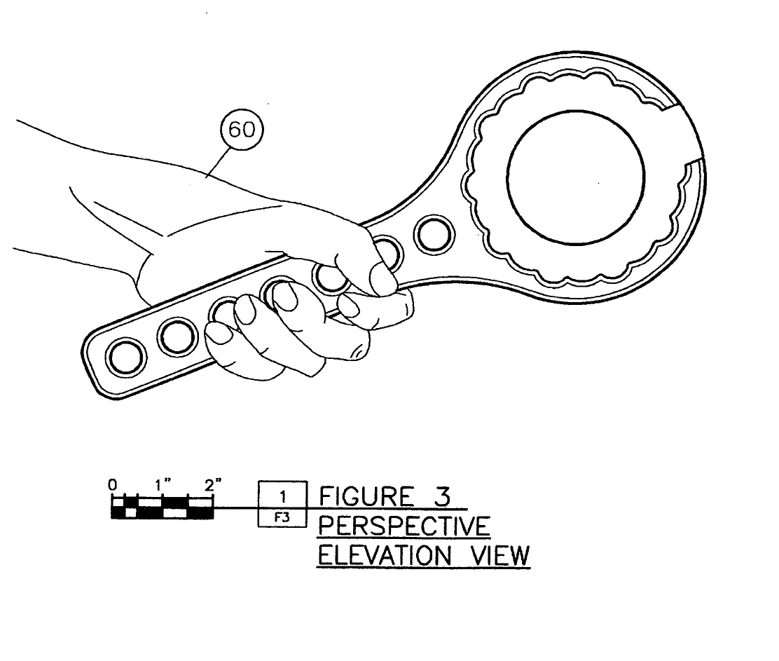

FIG. 3. 1st Embodiment, perspective, bottom view, relation to hand

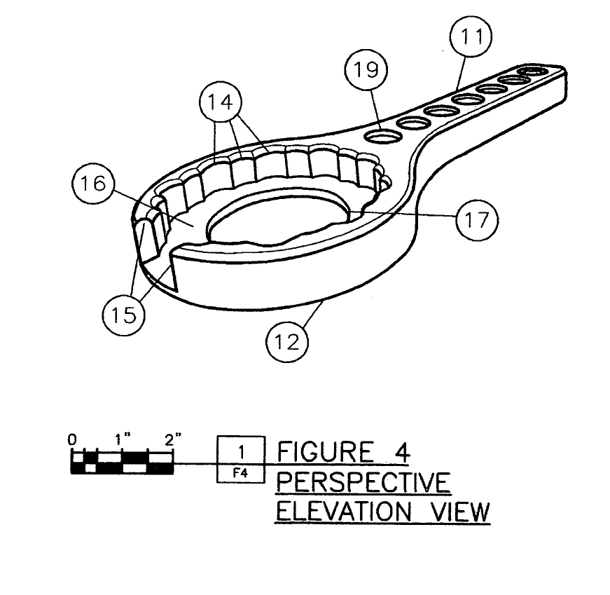

FIG. 4. 1st Embodiment, perspective, bottom view

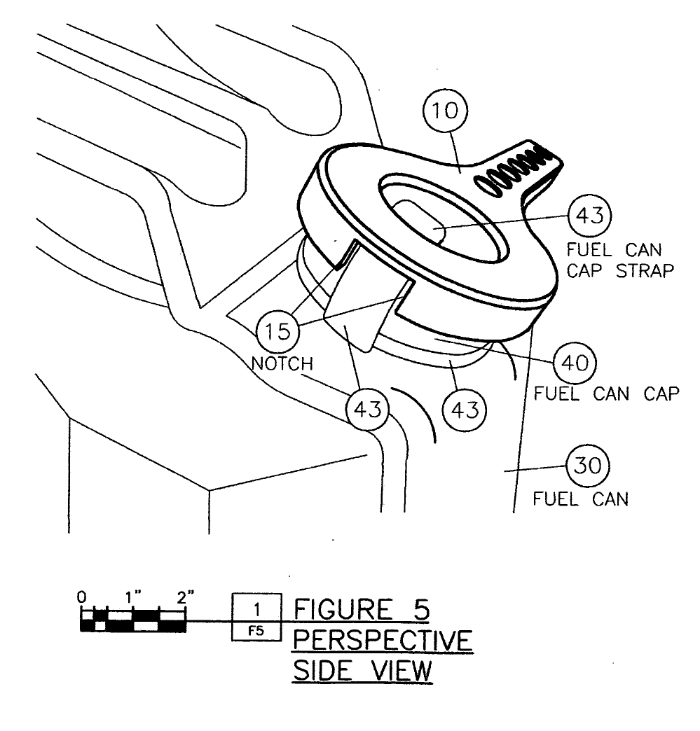

FIG. 5. 1st Embodiment, perspective, side view, seated on cap, showing notch to strap relation

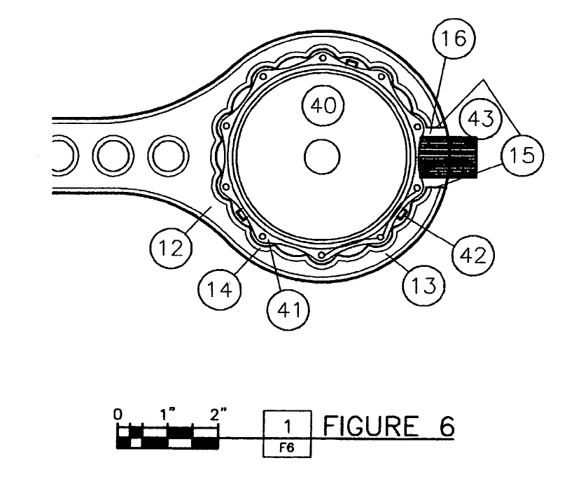

FIG. 6. 1st Embodiment, flat, bottom view, showing invention to cap relation

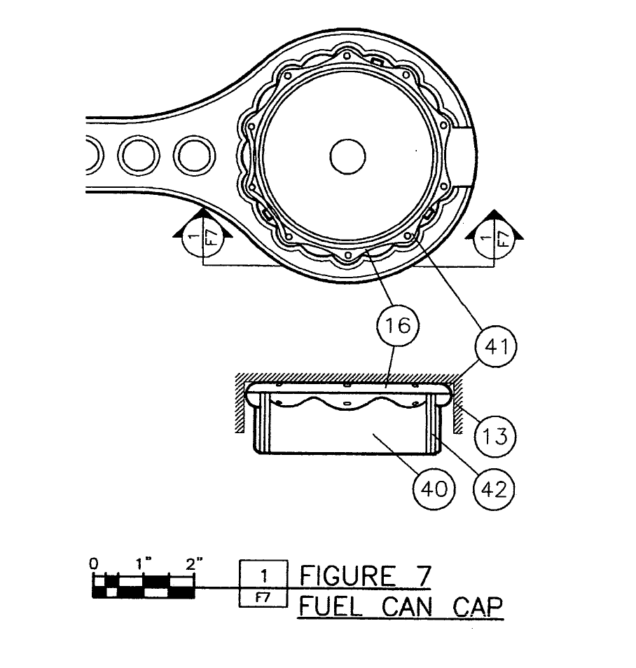

FIG. 7. 1st Embodiment, perspective, side view, cut away

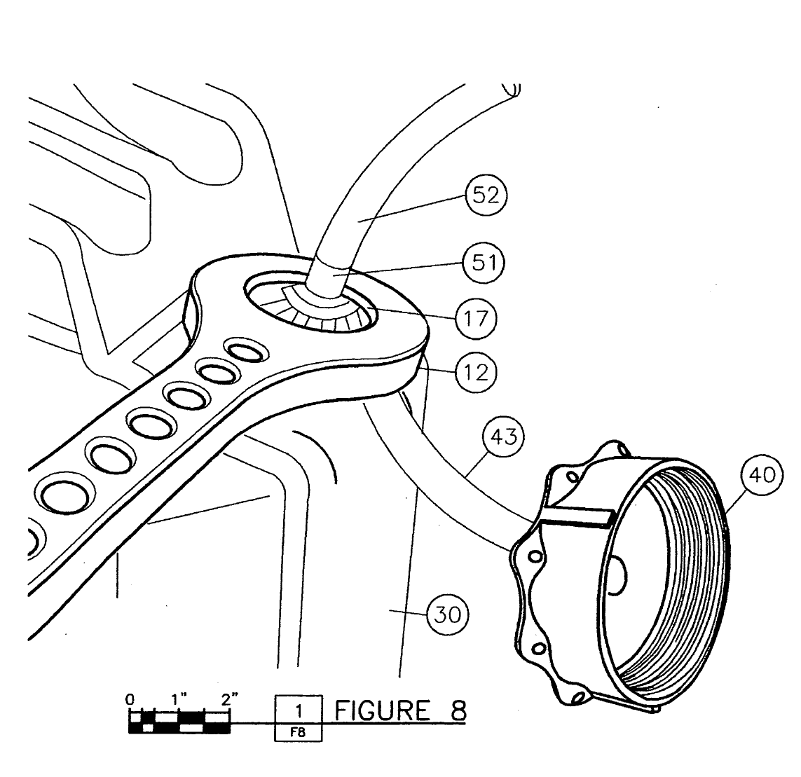

FIG. 8. 1st Embodiment, perspective, top view, seated on pour spout

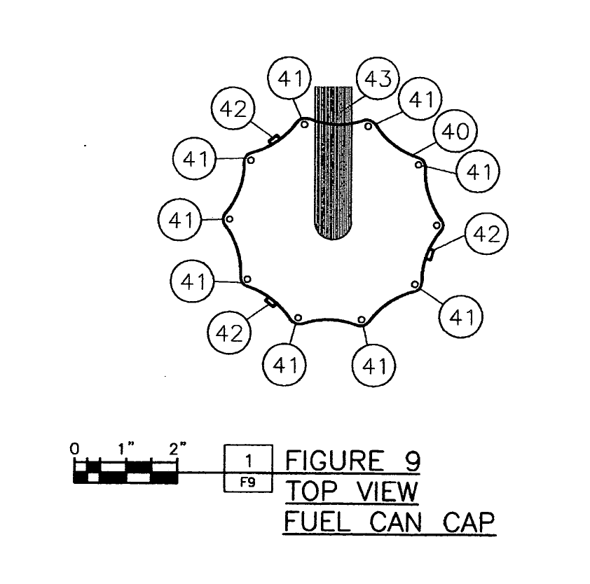

FIG. 9. Portable fuel container's cap, flat, top view

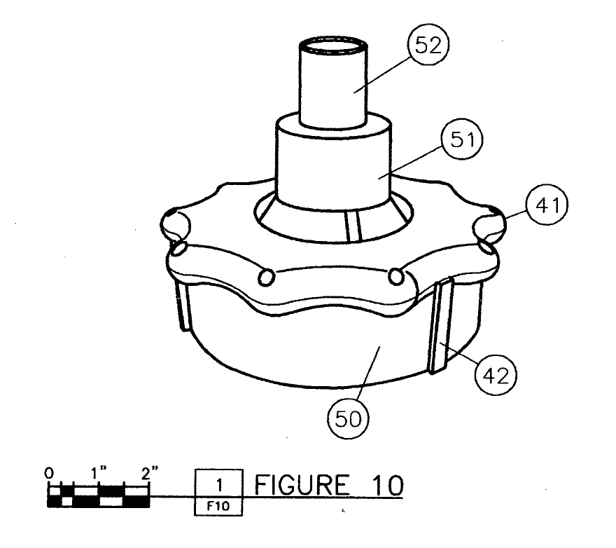

FIG. 10. Portable fuel container's pour spout, perspective, side view

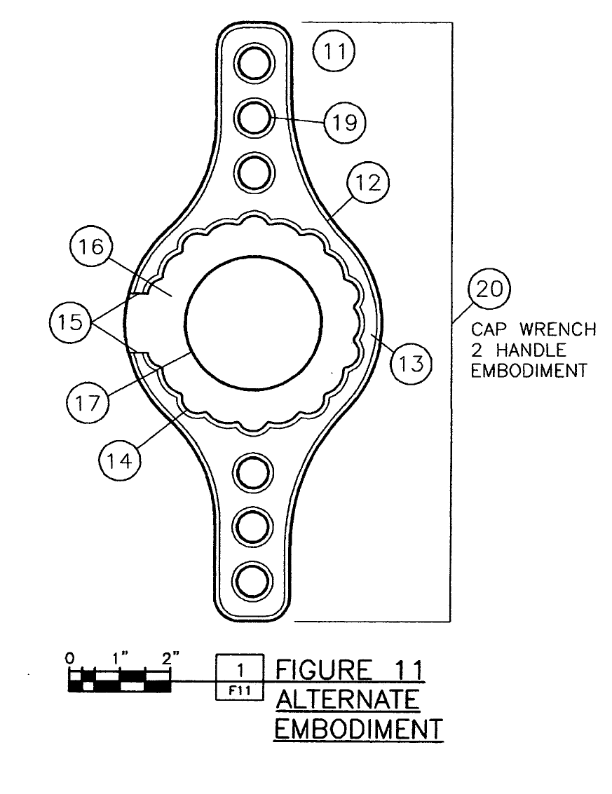

FIG. 11. 2nd Embodiment, flat, bottom view

### REFERENCE NUMERALS

10 1st embodiment

11 Handle

12 Head

13 Perimeter

14 Arcuate recesses in perimeter

15 Notch in perimeter

16 Recessed area in head

17 Pour spout hole

19 Bore(s)

20 2nd embodiment

30 Portable fuel container

40 Portable fuel container's cap

41 Lugs on the cap

42 Protrusions on the cap

43 Cap retention strap

50 Portable fuel container's pour spout

51 Cylindrical Protrusion on the pour spout

52 Fueling hose on the pour spout

60 Hand

### DETAILED DESCRIPTION

Reference will now be made in detail to the presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope and spirit thereof. Thus, is intended that the present invention covers such modifications and variations as come within the scope of the appended claims and their equivalents.

Referring to the drawings, and particularly to FIG. 1, a cap wrench 10 has a body with at least one handle 11, and a head generally denoted 12. The body may be formed from any suitable material, for example steel, alloy, polymers, etc. Head 12 is integrally formed with handle 11. Handle 11 has at least one bore 19 formed there-through, shown here as seven in number, that reduce overall weight of the invention, add functionality by providing multiple areas to be secured, stored or hung by, and allows for a more firm grasp. Instead of bores 19, other means of storing the invention may be provided.

As shown in FIG. 1, head 12 has an outer perimeter 13, with a notch 15, and a recessed area 16 extending inwardly from the perimeter 13 to a pour spout hole 17. The head 12 is of circular design. The perimeter wall 13 forms a recessed area 16 of sufficient size and shape to accept the cap of a portable fuel container 40, as best illustrated in FIG. 6.

Referring now to FIG. 4, the perimeter 13 has a plurality of arcuate recesses 14, shown here as nineteen in number. As best shown in FIG. 6, the arcuate recesses 14 cooperate with the lugs 41 and protrusions 42 of the fuel can cap 40 and pour spout 50. The arcuate recesses 14 supply the surface area needed in order to apply torque thereto, so as to facilitate rotation of the fuel can cap 40 or pour spout 50 for the purpose of loosening or tightening. The arcuate recesses 14 also allow clearance for the protrusions 42 when using this embodiment as described herein.

Now referring to FIG. 4, a notch 15 is located in the perimeter 13 of the head 12 of the invention. As shown in FIG. 5, a cap retention strap 43, attaches to the fuel can cap 40, and can freely rotate 360* in a clockwise or counterclockwise direction. As shown in FIGS. 5 and 6, the notch 15 is of sufficient size to easily accept the strap 43 when employing this invention as designed herein. Now referring to FIGS. 1 and 11, the notch 15 can be located in any portion of the perimeter 13 of head 12. In one embodiment, FIG. 1, the notch 15 is located directly across from and in line with the handle 11, and in another embodiment, FIG. 11, the notch 15 is placed perpendicular with respect to the handles 11. FIG. 5 shows the invention 10 fully seated on a fuel can cap 40 as it would be when employing this invention as described herein, with the strap 43 protruding out from the fuel can cap 40 through the notch 15.

The pour spout hole 17, as best illustrated in FIG. 2, is located in the center of the head 12 of the invention 10. The pour spout hole 17 is circular in shape. Now referring to FIG. 8, the pour spout hole 17 is of sufficient size to accept the upward protrusion 51 of the pour spout 50, while this embodiment is fully seated as it would be while using this invention as described herein. When the invention 10 is placed on the pour spout 50, the invention can be rotated clockwise or counterclockwise to tighten or loosen the pour spout 50 on the fuel can 30.

Now referring to the portion of the invention 10 intended to be gripped by a hand 60, generally referred to as a handle 11, illustrated in FIG. 3. At least one handle 11 of sufficient size and shape to be gripped by hand 60, shown here as one in number, tapers outwardly, and is integrally attached to the circular head 12 of the invention 10. As illustrated in FIG. 11, another embodiment, at least one handle 11 of sufficient size and shape to be gripped by hand 60, shown here as two in number, taper outwardly to the circular head 12 of the invention 20. In this embodiment, the head 12 is located between the two handles 11 forming a straight line. In both embodiments, the crenation of the edges of the handle 11 make a more preferable feeling when gripped by hand, but not necessary to it's function.

FIGS. 9 and 10 and descriptions thereof are included for the purpose of better explanation of the design and employment of all embodiments of this invention 10.

On a portable fuel container's cap, as illustrated in FIG. 9, there are a plurality of lugs 41, shown here as ten in number, and a plurality of protrusions 42, shown here as three in number, on a fuel can cap 40. The lugs 40 extend outwardly in a circular pattern, with arcuate recesses between each peak. The cap 40 also includes a cap retention strap 43. The cap retention strap 43 connects to the center of the cap 40, extending outwardly across the top of the cap 40, extending past the edge of the cap 40. The cap retention strap 43 is designed to rotate freely about the fuel can cap 40.

A portable fuel container's pour spout, as illustrated in FIG. 10, has the same plurality of lugs and protrusions as illustrated in FIG. 9. The center of the pour spout 50 protrudes upwardly 51.

An alternate embodiment is illustrated in FIG. 11. The head 12 connects at least one handle 11, shown here as two in number. The head 12 comprises of the perimeter 13, recessed area 16 and notch 15 as described in previous paragraphs.

What is claimed is:

1. A tool for removal of a portable fuel container cap having a scalloped, generally circular shape, said tool comprising:
1. A rotating tool having a head attached to at least one handle, said head having at least a notch formed therein, said notch adapted for receiving ribs extending from the fuel container cap.
2. A method for separating a cap from a portable fuel container, comprising:
engaging notches of the tool with ribs of the portable fuel container cap; and imparting direct torque to said cap.
